(19) United States
(12) Patent Application Publication
(10) Pub. No.: US 2020/0188864 A1
(43) Pub. Date: Jun. 18, 2020

(54) SELF-ASSEMBLED POLYMERIC VESICULAR STRUCTURES WITH FUNCTIONAL MOLECULES

(71) Applicant: AQUAPORIN A/S, Kongens Lyngby (DK)

(72) Inventors: Mariana SPULBER, Charlottenlund (DK); Karen GERSTANDT, Poyenberg (DE)

(21) Appl. No.: 16/348,949

(22) PCT Filed: Nov. 10, 2017
(86) PCT No.: PCT/EP2017/078888

§ 371 Date: May 10, 2019

(30) Foreign Application Priority Data
Nov. 11, 2016 (GB) 1619072.0

(51) Int. Cl. B01D 71/80; B01D 61/02; B01D 69/14; B01D 69/12; C02F 1/44

(52) U.S. Cl. CPC B01D 71/80; B01D 61/025; C02F 1/441; B01D 69/125; B01D 69/144

(57) ABSTRACT

Disclosed is a vesicle comprising polystyrene-polyacrylic acid (PS-PAA) block copolymer and an amphiphilic functional molecule. The vesicle is stable even at elevated temperatures and the amphiphilic functional molecule remains active. Also discloses is a selectively permeable membrane comprising a support layer and a selective layer incorporating the vesicles.

### FIELD OF THE INVENTION

The present invention relates to self-assembled vesicular nanostructures or microstructures comprising polystyrene-polyacrylic acid (PS-PAA) block copolymers or polymersomes having incorporated functional molecules, for example protein channels such as aquaporin water channels, and a method of preparing said structures.

In addition, the present invention relates to a selectively permeable water membrane comprising said self-assembled structures that incorporate aquaporin water channels or similar water channels, to modules for water filtration comprising the selectively permeable water membranes, and to the use of the membranes or modules for water extraction comprising the selectively permeable membranes. The present invention further relates to a method of preparing the selectively permeable membrane. The present invention discloses the self-assembly and functional reconstitution of aquaporin water channel proteins, such as AQPZ channel proteins, into PS-PAA amphiphilic block copolymer vesicular nanostructures or polymersomes for further incorporation in biomimetic membranes, the membranes being prepared both by TFC coating of a porous substrate or the layer-by-layer (LBL) membranes prepared by sequential layer-by-layer adsorption of oppositely charged polyelectrolytes on a porous substrate.

### BACKGROUND OF THE INVENTION

Amphiphilic block copolymers are unique compounds due to their ability to self-assemble into various morphologies including spheres, rods, vesicles, nanotubes, networks and lamellar aggregates (Zhang Y, Polymer, 2009). From all various morphologies vesicles that can be defined as spherical bilayers has attracted an increased interest due to their abilities to functional incorporation of proteins including amphiphilic or transmembrane proteins ensuring their protection and ability to perform their activities in a harsh environment, such as pH and temperature changes (Choucair A, Langmuir, 2004; Spulber M, JACS, 2013, Lomora, Biomaterials, 2015). That can be a useful feature, especially when incorporation of the channel proteins in biomimetic membranes is desired.

Polystyrene-polyacrylic acid (PS-PAA) block copolymers can due to their composition based on a PS block being neutral and hydrophobic and a PAA block being neutral or charged and relatively hydrophilic, can self-assemble into various morphologies especially core-shell micelles and flower-like aggregates in dependence on the ratio between the hydrophilic-hydrophobic block and the nature of the solvent used for dissolving and after precipitation in water (dioxane, tetrahydrofuran, toluene) (Shi L, New J Chem, 2004; Zhang Y, Polymer, 2009; Gao L, Macromol Chem and Phys, 2006). The core-shell micelles proved to be especially important due to their ability to load and release hydrophobic compounds, such as biocides (Vyhnalkova R, J Phys Chem B 2008). PS-PAA micelles were also shown to be able to fuse and form monolayers with potential interesting applications ranging from pharmaceuticals to ferrofluids (Guennouni Z, Langmuir, 2016; Wang X, Soft matter, 2013). Only two studies indicated the self-assembly of the PS-PAA copolymers in vesicular structure, both using the co-solvent method, such as first dissolving polymers in dioxane, tetrahydrofuran or dimethylformamide, followed by their precipitation in water to final ratios of maximum 40% (w/w) water concentration (Choucair A, Langmuir, 2004; Terreau O, Langmuir, 2004). The size of the formed PS-PAA vesicles obtained was strongly dependent of the total content of water in the mixture, and the presence of various additives such as NaOH and, NaCl that may lead to larger structures (200 nm diameter and higher) or HCl that may lead to structures smaller than 100 nm (Choucair A, Langmuir, 2004; Terreau O, Langmuir, 2004). Nevertheless, the above mentioned conditions would prevent the insertion of any protein, and especially transmembrane proteins that are amphiphilic, as the high percentage of the organic solvent will lead to protein unfolding and denaturation.

WO2015/124716 discloses a system for utilizing the water content in fluid from a renal replacement process. The system includes a forward osmosis unit with a forward osmosis membrane. The forward osmosis membrane may include aquaporin water channels incorporated into a vesicle being self-assembled of amphiphilic matric forming compounds in the presence of an aquaporin protein preparation. The amphiphilic matric forming compounds are exemplified by azolectin and polyoxazoline based triblock copolymers.

US2013/0316008 discloses a method for forming a multi-compartmentalized vesicular structure comprising an outer block copolymer vesicle and an inner block copolymer vesicle encapsulated inside the outer block copolymer vesicle. The compounds that form the vesicular structures are triblock copolymers based on methyloxazoline and dimethylsiloxane (PMOXA-PDMS-PMOXA) and diblock copolymers based on styrene and isocyanoalanine (PS-PIAT). Furthermore, the protein Cy5-IgG was captured in the space between the outer surface of the inner vesicle and the inner surface of the outer vesicle.

US 2014/0051785 discloses a method for preparing high density membrane protein membranes by slow, controlled removal of detergent from mixtures of detergent, block copolymers and membrane protein mixtures. The membranes may incorporate aquaporin proteins, like AQPO proteins. The blockcopolymers may contain one or more blocks selected from polybutadiene (PB), polydimethylsiloxane (PDMS), polypropylene (PP), polypropylene oxide (PPO), polyethylethylene (PEE), polyisobutylene (PIB), polyisoprene (PI), polycaprolactone (PCL), polystyrene (PS), fluorinated polymers, and polymethylmethacrylate (PMMA); and one or more hydrophilic blocks selected from the group consisting of polymethyloxazoline (PMOXA), polyethyloxazoline (PEtOXA), and polyethylene oxide (PEO).

Aquaporin incorporating polydimethylsiloxane-polymethyl oxazoline (PDMS-PMOXA) amphiphilic vesicles have been used for Aquaporin Inside™ biomimetic membrane preparation, e.g. as described in WO 2015/166038. However, these vesicles exhibit a relatively narrow packing density, possibly due to relatively weak adsorption to the substrate membrane. The vesicles also have relatively restricted stability when subjected to increasing mechanical or pressure stress, especially when pressure is a driving force of water flux through biomimetic membrane, as would be the case of reverse osmosis (RO) membranes.

Kim, RCS Advances, 2014, describes mechanical strength of the polystyrene block; however, without showing the feasibility of preparing PS-PAA block copolymer vesicles in an aqueous environment suitable for sensitive molecules, such as amphiphilic or transmembrane proteins or protein channels, e.g. aquaporins.

### SUMMARY OF THE INVENTION

In an aspect, the present invention provides a vesicle comprising polystyrene-polyacrylic acid (PS-PAA) block copolymer and an amphiphilic functional molecule. Surprisingly, it has been discovered that the amphiphilic functional molecule remains functional after incorporation in the vesicle. Furthermore, the vesicle formulation is stable in the temperature range of from room temperature (20° C.) to about 100° C., which indicates the industrial applicability of the vesicle for the production of membranes for filtering a variety of aqueous fluids.

The PS-PAA block copolymer maybe of any size suitable for the formation of a vesicle. In a preferred aspect the block copolymer has a molecular weight of from about 7500 Da to about 25000 Da. Specific commercially available grades include PS-PAA block copolymers having the molecular weights 8000 Da, 13000 Da and 23300 Da.

While the hydrophilic to hydrophobic ratio may be within wide ranges, the PS-PAA block polymer generally has a hydrophilic to hydrophobic ratio in the range of from about 0.4 to about 3.6. In certain embodiments of the present invention the PS-PAA block copolymer has an end functionalization which may be used for cross-linking or other purposes. Suitably, the end functionalization is selected from an azide group, a carboxyl group, or DDMAT group exhibiting a thiol moiety. When the end functionalization is a DDMAT group in the presence of an S—S bond can be applied for reaction with a molecule that contains a SH group such as 2-propene-1-thiol useful for further cross-linking and 5-fluorobenzoxazole-2-thiol useful for spectroscopic characterization.

As the PAA block of the PS-PAA copolymer is a weak electrolyte with pKa around 4.7, the charge of the formed structures can be tuned up from complete neutral to fully negatively charged at pH higher than 5. When the vesicles are incorporated in a thin film composite (TFC) layer the carboxylic acid groups in PAA block can react with the trimesoyl chloride (TMC) or similar polyfunctional carboxylic acid chloride compound, for the formation of a covalent bonding. In this way, the polyacrylic acid is used as the monomer for the thin film composite (TFC) coating [Pan, Poly Bull, 2014], contributing to a relatively increased packing density and mechanical stability in the membrane. The possibility for increased the packing density of the vesicles in a TFC layer results in a higher water flux through the membrane. Thus, improved filter membranes exhibiting higher water flux may be obtained using the vesicles of the present invention. Due to the charged nature of the AqpZ PS-PAA vesicles of the invention, they can be easily incorporated in LBL membranes. PS-PAA was used with success in the literature as an anionic component for LBL membranes [Guennouni Z, Langmuir, 2016]. Another suitable anionic polyelectrolyte is poly(styrene sulfonate) (PSS). The cationic polyelectrolyte may be selected as poly(diallyldimethylammonium chloride) (PDADMAC), polyallylamine (PAH) or similarly positive charged polymer. Thus, also for LBL membranes use of the vesicles according to the invention provides for a higher water flux.

In a further aspect, the present invention provides a vesicle, or a composition comprising vesicles, wherein the vesicles comprise PS-PAA block copolymer and an amphiphilic functional molecule. Preferably the vesicles have a hydrodynamic diameter of from about 50 nm to about 300 nm. Optionally, the vesicles further comprises a detergent, such as lauryldimethylamine-N-Oxide (LDAO) and octyl glucoside (OG). The detergent may be used in a concentration in the range of 0.05 to 2.5% v/v. By way of examples the amphiphilic functional molecules may be selected from the group of amphiphilic peptides and transmembrane proteins, such as aquaporin water channels.

In an aspect, the present invention relates to a composition comprising a functional molecule in combination with a PS-PAA block copolymer, in the form of an emulsion or a mixture prepared by direct dissolution in an aqueous medium in the presence of a detergent.

The present invention also provides a novel method of forming PS-PAA self-assembled vesicles by direct dissolution in an aqueous medium, such as a phosphate or other saline buffer, in the presence of a detergent, optionally with incorporation of transmembrane proteins, such as aquaporin water channels. The present inventor found that the use of detergent helps to promote the insertion of the transmembrane proteins in polymer vesicles, as it is one of the components used for transmembrane protein purification and preservation. This may be contrasted with the conditions used in the prior art for the production PS-PAA vesicles in which the presence of substantial amounts (e.g. 40%) organic solvents, such as dioxane or dimethylformamide, makes the processes unsuitable for incorporating transmembrane proteins as the solvents cause protein denaturation during self-assembly process. It is preferred that the vesicles of the present invention are not formed in the presence of substantial amounts of organic solvents, e.g. less than 40%, 20%, 10% or substantially free of organic solvents, such as dioxane or dimethylformamide.

In a further aspect, the present invention provides a selectively permeable membrane comprising a support layer and a selective layer wherein the membrane comprises vesicles of the present invention incorporated in the selective layer. The porous support membrane should not substantially impede the flux of water and/or the ion transported by the transmembrane protein. The main purpose of the porous support membrane is to serve as a scaffold for the active layer incorporating the vesicles, thus allowing the transmembrane protein to be the predominate discriminating element. By way of example, the selective layer may be a thin-film composite (TFC) layer or a layer-by-layer (LBL) structure. In some embodiments, the vesicles are fully negatively charged at pH>5, which offers the possibility of increased vesicle packing density in the selective layer.

In addition, in a further aspect, the present invention provides a selectively permeable membrane having aquaporin water channels, where said channels are encapsulated in polystyrene-polyacrylic acid block copolymers where examples of said membranes include flat sheet membranes, hollow fibre membranes and tubular membranes.

In a further aspect, the present invention provides the use of a membrane of the present invention in a low pressure reverse osmosis (LPRO) process, for example in a water purification process.

In a further aspect, the present invention provides a low pressure reverse osmosis apparatus for water purification comprising the selectively permeable membrane of the present invention. By way of example the low pressure reverse osmosis apparatus may be is a household water purifier operating at a pressure below about 5 bar.

In a further aspect, the present invention provides a brackish water reverse osmosis (BWRO) apparatus comprising the selectively permeable membrane of the present invention.

Embodiments of the present invention will now be described by way of example and not limitation with reference to the accompanying examples. However, various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

### DETAILED DESCRIPTION OF THE INVENTION

More specifically, the present invention describes a novel approach for PS-PAA self-assembly by direct dissolution in a phosphate saline buffer, such as having a pH=7.2 or the like, in the presence of various ratios of a detergent, such as lauryldimethylamine N-oxide (LDAO) or octyl glucoside (OG), and with and without transmembrane protein incorporation as obtained by addition of an AqpZ dispersion having a concentration of from 1 to 100 mg/L or such as from 5 to 50 mg/L, and where the components are stirred or shaken up to 24 hours. The PS-PAA self-assembled structures of the present invention having vesicle sizes, e.g. as measured hydrodynamic diameter (Dz), in a desired range of from above 40 nm to 300 nm, such as from about 90 to 100 nm to about 200 to 250 nm, may also be obtained in the same way by varying the PS-PAA block copolymer's molecular weight and its hydrophilic to hydrophobic ratio and the detergent (e.g. LDAO, OG etc.) concentration, cf. Example 4 below. The successful reconstitution of AqpZ inside the formed PS-PAA structures was also obtained, and suitable conditions for the AqpZ reconstitution are disclosed in Example 3 below. Furthermore, the stability of the formed structures was established in the temperature range of from 30 to 100° C., which renders the self-assembled structures useful and suitable for incorporation in biomimetic membranes that may have to withstand various temperatures while still preserving their functionality and especially the water transporting functionality of incorporated aquaporin water channels.

### Definitions

The term “PS-PAA” as used herein includes poly(styrene)-block-poly(acrylic acid), also known as PS-PAA amphiphilic diblock copolymers and polystyrene-polyacrylic acid polymersome forming polymer having the linear formula Ha[(C₆H₅)CHCH₂]ₓ [(CO₂H)CHCH₂]_{y} C(CH₃)₂C(O)OCH₂CH₃, cf. http://www.sigmaaldrich.com/catalog/search?term=PS-PAA&interface=All&N=0&mode=mode%20matchall&lang=en&region=DK&focus=product. wherein Ha=halogen such as F, Cl or Br, x=28 and y=70. Examples of PS-PAA diblock copolymers useful herein include Polystyrene-block-poly(acrylic acid) 130000 Da P19511-SAA PolymerSource; Polystyrene-block-poly(acrylic acid) 128000 Da P19513-SAA PolymerSource; Polystyrene-block-poly(acrylic acid) 230000 Da P3001-SAA PolymerSource.

The PS-PAA diblock copolymers may be terminally functionalized, such as having a DDMAT group, where DDMAT is 2-(Dodecylthiocarbonothioylthio)-2-methylpropanoic acid, S-Dodecyl-S′-(α,α′-dimethyl-α″-acetic acid)trithiocarbonate. http://www.sigmaaldrich.com/catalog/product/aldrich/723010?lang=en&region=DK. The DDMAT terminated PS-PAA block copolymer may be useful due to the presence of an S—S bond that can easily be used for functionalization with any functional molecule that contains an SH group, such as 2-Propene-1-thiol which is useful for further cross linking and 5-Fluorobenzoxazole-2-thiol being useful for spectroscopic characterisation. Other types of terminal functionalization include azide and carboxyl terminated PS-PAA polymers.

The term “transmembrane protein” as used herein includes any protein that occurs naturally in monomeric or multimeric form as inserted in a biological bilayer membrane, such as a cell or an organelle membrane. Transmembrane proteins are typically amphiphilic. Transmembrane proteins tend to aggregate and precipitate in aqueous solutions and it may therefore be suitable that the transmembrane protein is solubilized in a detergent. While a number of detergent may be used, generally the detergent is selected from the group consisting of lauryldimethylamine N-oxide (LDAO), octyl glucoside (OG), dodecyl maltoside (DDM) or combinations thereof. Preferred examples are aquaporin and aquaglyceroporin proteins, e.g. prokaryotic Aquaporin Z (AqpZ) and eukaryotic aquaporins, such as human aquaporin 1 and 2, and spinach SoPIP2;1. Further aquaporin water channels include bacterial aquaporins and eukaryotic aquaporins, such as yeast aquaporins, plant aquaporins and mammalian aquaporins, as well as related channel proteins, such as aquaglyceroporins. Examples of aquaporins and aquaglyceroporins include: prokaryotic aquaporins such as AqpZ; mammalian aquaporins, such as Aqp1 and Aqp2; plant aquaporins, such as plasma intrinsic proteins (PIP), tonoplast intrinsic proteins (TIP), nodulin intrinsic proteins (NIP) and small intrinsic proteins (SIP), e.g. SoPIP2;1, PttPIP2;5 and PtPIP2;2; yeast aquaporins, such as AQY1 and AQY2; and aquaglyceroporins, such as GlpF and Yfl054. Aquaporin water channel proteins may be prepared according to the methods described herein or as set out in Karlsson et al. (FEBS Letters 537: 68-72, 2003) or as described in Jensen et al. US 2012/0080377 A1 (e.g. see Example 6).

“Hydrodynamic diameter” as used herein represents the hydrodynamic size of nanoparticles in aqueous media measured by dynamic light scattering (DLS) defined as the size of a hypothetical hard sphere that diffuses in the same fashion as that of the particle being measured, for example using a ZetaSizer NanoZs from Malvern and stopped-flow using a Bio-Logic SFM 300.

In a preferred aspect of the invention, the active layer comprises the vesicles incorporated in a thin film composite layer formed on a porous substrate membrane. Without wishing to be bound by any particular theory, it is believed that the vesicles containing carboxylic acid groups on the surface will be not only physically incorporated or immobilized in (adsorbed), but, in addition, chemically bound in the TFC layer, because the reactive acid groups, will participate in the interfacial polymerization reaction with the acyl chloride, such as a trimesoyl chloride (TMC). In this way, it is believed that vesicles will be covalently bound in the TFC layer, leading to relatively higher vesicle loading and thus higher water flux through the membranes. In addition, it is believed that the covalent coupling of vesicles in the TFC layer results in higher stability and/or longevity of the aquaporins and aquaporin-incorporated vesicles when incorporated in the selective membrane layer.

Furthermore, when said transmembrane protein comprises an ion channel or an aquaporin or the like, and said vesicles comprising said transmembrane protein are immobilized or incorporated in said active or selective layer, it becomes feasible to manufacture separation membranes or filtration membranes having diverse selectivity and transport properties, e.g. ion exchange membranes when said transmembrane protein is an ion channel, or water filtration membranes when said transmembrane protein is an aquaporin. Because the transmembrane protein maintains its biologically active folded structure when complexed into the self-assembled vesicles wherein it may be shielded from degradation. Even sensitive amphiphilic proteins may become sufficiently stable and, thus, preserve their desired functionality when processed into separation membranes in lab and industrial scale.

The present invention further relates to a method of preparing a thin film composite layer immobilizing vesicles incorporating a transmembrane protein on a porous substrate membrane, comprising the steps of

a. Providing an aqueous solution comprising the vesicles prepared as mentioned above and a di-amine or tri-amine compound,

b. Covering the surface of a porous support membrane with the aqueous solution of step a,

c. Applying a hydrophobic solution comprising an acyl halide compound, and

d. Allowing the aqueous solution and the hydrophobic solution to perform an interfacial polymerization reaction to form the thin film composite layer.

The di-amine compound may be selected among a range of compounds including for example, phenylenediamines, such as m-phenylenediamine (MPD), p-phenylenediamine, 2,5-dichloro-p-phenylenediamine, 2,5-dibromo-p-phenylenediamine, 2,4,6-trichloro-m-phenylenediamine, 2,4,6-tribromo-m-phenylene-diamine, etc; diaminobiphenyls, such as 2,2′-diamino-biphenyl, 4,4′-diaminobiphenyl, 3,3′-dichloro-4,4′-diamino-biphenyl, 3,5,3′,5′-tetrabromo-4,4′-diaminobiphenyl, etc; diaminodiphenylmethanes, such as 4,4′-diaminodiphenylmethane, 3,3′-diaminodiphenylmethane, 2,2′-diaminodiphenyl-methane, 3,3′-dichloro-4,4′-diaminodiphenylmethane, 2,2′-dichloro-4,4′-diaminodiphenylmethane, 3,5,3′,5′-tetrachloro-4,4′-diaminodiphenylmethane, 3,5,3′,5′-tetrabromo-4,4′-diaminodiphenylmethane, etc.; diaminobibenzyls, such as 4,4′-diaminobibenzyl, 3,5,3′,5′-tetrabromo-4,4′-diamino-bibenzyl, etc.; 2,2-bisaminophenylpropanes, such as 2,2-bis(4′-aminophenyl)propane, 2,2-bis(3′,5′-dichloro-4′-amino-phenyl)propane, 2,2-bis(3′,5′-dibromo-4′-aminophenyl)-propane, etc.; diaminodiphenylsulfones, such as 4,4′-diamino-diphenylsulfone, 3,5,3′,5′-tetrachloro-4,4′-diamino-diphenylsulfone, 3,5,3′,5′-tetrabromo-4,4′-diaminodiphenyl-sulfone, etc.; diaminobenzophenones, such as 4,4′-diamino-benzophenone, 2,2′-diaminobenzophenone, 3,3′-dichloro-4,4′-diaminobenzophenone, 3,5,3′,5′-tetrabromo-4,4′-diamino-benzophenone, 3,5,3′,5′-tetrachloro-4,4′-diaminobenzo-phenone, etc.; diaminodiphenyl ethers, such as 3,3′-diamino-diphenyl ether, 4,4′-diaminodiphenyl ether, 3,3′-dibromo-4,4′-diaminodiphenyl ether, etc. piperazine, N-phenyl-benzene-1,3 diamine, melanine, and mixtures of such compounds. In a preferred aspect, the diamine is selected as m-phenylenediamine (MPD) also known as 1,3-diaminobenzene.

The tri-amine compound may be selected among a range of compounds including for example, diethylene triamine, dipropylene triamine, phenylenetriamine, bis(hexamethylene)-triamine, bis(hexamethylene)triamine, bis(3-aminopropyl)-amine, hexamethylenediamine, N-tallowalkyl dipropylene, 1,3,5-triazine-2,4,6-triamine, and mixtures of these compounds.

The acyl halide compound usually has two or three acyl halide groups available for reaction with the di- or triamine compound. Suitable examples of diacyl halide or triacyl halide compounds include trimesoyl chloride (TMC), trimesoyl bromide, isophthaloyl chloride (IPC), isophthaloyl bromide, terephthaloyl chloride (TPC), terephthaloyl bromide, adipoyl chloride, cyanuric chloride and mixtures of these compounds.

The amine groups of the di-amine or tri-amine compound will compete with the acid chloride groups of the acyl halide compound for reaction. Generally, the proportion by weight of the di-amine or tri-amine compound to acyl halide compound is from 0:1 to 30:1. When a high density of vesicles on the surface is required the amount of di-amine or tri-amine groups is usually in the lower part of the range, i.e. 0:1 to 1:1, such as between 0:1 to 0.5:1. In other embodiments of the invention, a more rigid TFC layer is desired and a selection of the reactants are in the higher end of the range, such as 1:1 to 30:1, preferably 1:1 to 5:1.

The porous support membrane may be formed by a number of materials. The specific choice of material is not essential as long as the support membrane is able sufficiently to support the TFC layer and to withstand decomposition during operation condition, i.e. able to withstand the pressure and/or the chemical environment on either side of the membrane. Specific examples of materials for the porous support membrane include polysulfone or a polyethersulfone polymer. The support may be symmetrical or asymmetrical. In the case the porous support membrane is asymmetrical, the TFC layer is suitably formed on the skin layer face.

The porous support membrane may further be supported by a woven or non-woven mechanical support in some embodiments to increase the mechanical construction and reduce the risk of fractures during operation.

The porous support membrane may any physical appearance known in the art, such as flat sheet membrane, tubular membrane, or hollow fiber membrane. In a certain aspect of the invention a hollow fiber membrane is preferred as it provides for higher packing density, i.e. the active membrane area is higher for a certain volume. The membranes may be grouped together or assembled into a module as known in the art. Thus, a plurality of flat sheet membranes may be assembled into a plate-and-frame membrane configuration. Plate-and-frame membrane systems utilize membranes laid on top of a plate-like structure, which in turn is held together by a frame-like support.

Flat sheet membranes may also be assembled into spiral-wound filter modules. In addition to the flat sheet membranes, the spiral-wound membrane modules include feed spacers, and permeate spacers wrapped around a hollow tube called the permeate tube. Spiral wound elements utilize cross flow technology, and because of its construction, can easily be created in different configurations with varying length, diameter, and membrane material. A spiral-wound filter module may be produced by first laying out a membrane and then fold it in half with the membrane facing inward. Feed spacer is then put in between the folded membranes, forming a membrane sandwich. The purpose of the feed spacer is to provide space for water to flow between the membrane surfaces, and to allow for uniform flow between the membrane leaves. Next, the permeate spacer is attached to the permeate tube, and the membrane sandwich prepared earlier is attached to the permeate spacer using glue. The next permeate layer is laid down and sealed with glue, and the whole process is repeated until all of the required permeate spacers have been attached to the membranes. The finished membrane layers then are wrapped around the tube creating the spiral shape.

Tubular membrane modules are tube-like structures with porous walls. Tubular modules work through tangential cross-flow, and are generally used to process difficult feed streams such as those with high dissolved solids, high suspended solids, and/or oil, grease, or fats. Tubular modules consist of a minimum of two tubes; the inner tube, called the membrane tube, and the outer tube, which is the shell. The feed stream goes across the length of the membrane tube and is filtered out into the outer shell while concentrate collects at the opposite end of the membrane tube.

The hollow fiber membranes may be assembled into a module. Thus, the present invention provides the step of producing a hollow fiber module by assembling a bundle of hollow fibers in a housing, wherein an inlet for passing a first solution is connected to the lumen of the hollow fibers in one end and an outlet is connected to the lumen in the other end, and an inlet is provided in the housing for passing a second solution to an outlet connected to the housing.

The membrane modules produced in accordance with the present invention may be used in various configurations, including forward osmosis configurations and reverse osmosis configurations.

Forward osmosis (FO) is an osmotic process that uses a selectively-permeable membrane to effect separation of water from dissolved solutes. The driving force for this separation is an osmotic pressure gradient between a solution of high concentration, herein referred to as the draw and a solution of lower concentration, referred to as the feed. The osmotic pressure gradient induces a net flow of water through the membrane into the draw, thus effectively concentrating the feed. The draw solution can consist of a single or multiple simple salts or can be a substance specifically tailored for forward osmosis applications. The feed solution can be a dilute product stream, such as a beverage, a waste stream or seawater, cf. IFOA, http://forwardosmosis.biz/education/what-is-forward-osmosis/

Most of the applications of FO, thus fall into three broad categories: product concentration, waste concentration or production of clean water as a bi-product of the concentration process. The term “PAFO” when used herein describes a pressure assisted forward osmosis process. The term “PRO” when used herein describes pressure retarded osmosis which is useful in the generation of osmotic power. Membranes of the present invention are useful in all types of forward osmosis processes and may be specifically adapted for each FO type.

The term “reverse osmosis” (RO) is used herein refers to when an applied feed water pressure on a selectively permeable membrane is used to overcome osmotic pressure.

Reverse osmosis typically removes many types of dissolved and suspended substances from feed water, including bacteria, and is used in both industrial processes and in the production of potable water. During the RO process, the solute is retained on the pressurized side of the membrane and the pure solvent, the permeate, passes to the other side. Selectivity specifies that the membrane does not allow larger molecules or ions through its pores (holes), while allowing smaller components of the solution (such as solvent molecules) to pass freely. Low pressure reverse osmosis (LPRO) membranes typically operates at a feed water pressure of from about <5 bar and up to a maximum operating pressure of about 25 bar 15 specific flux LMH/bar. LPRO performed at the lower feed pressure ranges, e.g. 2 to 5 bar is sometimes designated ultra-low pressure reverse osmosis. LPRO membranes known in the art have typical operating limits for feed water temperature of about 45° C., feed water pH in the range of 2 to 11, and chemical cleaning in the range of pH 1 to 12.

The present invention relates more specifically to an aqueous composition comprising PS-PAA block copolymer vesicles having incorporated an amphiphilic functional molecule in the presence of a detergent. In certain embodiments, the aqueous composition is essentially free of apolar solvents. Examples of said functional molecule include an amphiphilic peptide or protein, such as a transmembrane protein, such as an aquaporin water channel, e.g. aquaporin Z, or SoPIP2;1 and other plant aquaporins, or aquaporin-1, or aquaporin-2. More specifically said copolymer is selected from PS-PAA block copolymers having a hydrophilic to hydrophobic ratio in the range of from 0.4 to 3.6; and the molar ratio of polymer:detergent:AqpZ is in the range of from about 1:0.017:0.0008 to 1:0.19:0.0047.

In addition, examples of said PS-PAA copolymer are selected from block copolymers having a molecular weight (Mw) of from about 8000 Da to about 25000 Da, such as block copolymers having the molecular weights 8000 Da, 13000 Da and 23300 Da.

In the composition of the invention, the detergent may be selected from LDAO and OG and said detergent may be present in a concentration of from about 0.05 to about 2.5% v/v.

In addition, the invention relates to a vesicle comprising PS-PAA block copolymer and an amphiphilic functional molecule. In certain embodiments, the vesicle has a hydrodynamic diameter of from about 50 nm to about 200 nm, such as from about 55 nm to about 100 nm; and the vesicle further comprises a detergent, such as LDAO or OG; and the amphiphilic functional molecule is selected from the group of amphiphilic peptides and transmembrane proteins, such as aquaporin water channels.

In exemplary embodiments of the present invention, the vesicle is stable in admixture with MPD for at least about 6 h, more preferably at least about 12 h, more preferably at least about 18 hours and most preferably up to about 24 hours.

The present invention further relates to a selectively permeable membrane comprising a porous support layer and a dense or non-porous selective layer wherein the vesicles of the invention are incorporated. The membrane ma y be in the form of a flat sheet membrane or a hollow fiber membrane or a tubular membrane. The membrane of the invention is useful for filtration of water using forward osmosis or reverse osmosis. Low pressure reverse osmosis (LPRO) membranes typically operates at a feed pressure of from about 5 to 10 bar and a specific flux of about 15 LMH/bar. The lower feed pressure ranges, e.g. <5 bar are sometimes designated ultra-low pressure reverse osmosis. Thus, an aspect of the present invention relates to the use of the selectively permeable water membrane of the invention in a low pressure reverse osmosis (LPRO) process, such as a water purification process utilizing a natural water source or a surface or ground water source as feed water.

In some embodiments, the selectively permeable membranes of the present invention may further be subjected to a surface treatment on the selective layer or the separation layer, for example to provide a coating layer over the selective layer and/or the separation layer. By way of example, this may take the form of a thin coating comprising hydrophilic polydopamine, cf. Environ. Sci. Technol. Lett., 2016, 3 (9), pp 332-338 for antifouling purposes, or as a PVA coating, cf. U.S. Pat. No. 6,413,425, for the improvement of parameters such as salt rejection, fouling tolerance etc.

In a further aspect, the present invention provides a low pressure reverse osmosis apparatus for water purification comprising the selectively permeable membrane of the invention, where an example of said apparatus is a household water purifier operating at a pressure below about 5 to 10 bar, such as between 2 to 5 bar.

An additional aspect of the present invention is a brackish water reverse osmosis (BWRO) apparatus comprising the selectively permeable membrane of the invention. The selectively permeable membranes of the present invention may be used for brackish water desalination, where the incorporation of active aquaporin water channels in the selective layer provides for improved flux and reduced energy consumption compared to traditional systems.

The present invention is versatile in that it provides PS-PAA self assembled vesicles or polymersomes that may encapsulate or incorporate a range of functional molecules having both amphiphilic, hydrophilic or hydrophobic nature. For this purpose, the functional molecule may be mixed directly with the mixture of PS-PAA and suitable aqueous detergent to ensure encapsulation inside the vesicle for hydrophilic compounds or inside the PS block for the hydrophobic compound or aligned in the amphiphilic vesicle membrane for amphiphilic compounds, e.g. certain peptides (e.g. insulin) or transmembrane molecules or proteins, and the encapsulated molecules may then be released in controlled conditions.

### EXAMPLES

The present invention is further illustrated by the following examples which should not be construed as further limiting.

### General Protocols

### Example 1. Direct Dissolution of PS-PAA in Phosphate Buffer pH=7.2 in Presence of LDAO to Form Self-Assembled Vesicles

Materials and Methods

Polystyrene-block-poly(acrylic acid), DDMAT terminated (MW 8000 Da) (PS-PAA 3000:5000, PDI<1.1) was purchased from Sigma-Aldrich (HOCOC(CH₃)₂(CH₂CHC₆H₅)ₘ(CH₂CHCOOH)ₙSCSSC₁₂H₂₅) wherein m=28 and n=70, and was used as received without any other purification. 10 mM phosphate saline solution (PBS) (pH 7.2, 136 mM NaCl, 2.6 mM KCl) was prepared by dissolving 8 g NaCl, 0.2 g KCl, 1.44 g Na₂HPO₄ and 0.24 g of KH₂PO₄ in 800 mL MiliQ purified H₂O, adjusting the pH to 7.2 with HCL and completing the volume to 1 L. N,N-Dimethyldodecylamine N-oxide BioXtra (Lauryldimethylamine N-oxide) (99% purity), LDAO was purchased from Sigma Aldrich.

PS-PAA incorporating AqpZ vesicles were prepared by LDAO mediated direct dissolution method. For that 200 mg PS-PAA powder were mixed with 0.5 mL 5% LDAO stock solution and 195 mL PBS.

The PS-PAA, LDAO mixture was stirred overnight at 170 rotations per minute, overnight not more than 24 hours (but not less than 12 h). After stirring next day, the mixture was transferred in 100 mls glass bottle and kept at room temperature. After transfer to the storage glass bottle the size and the permeability of the PS-PAA self-assembled structures (vesicles) and zeta potential were determined by dynamic light scattering using a ZetaSizer NanoZs from Malvern and stopped-flow using a Bio-Logic SFM 300.

The hydrodynamic diameter of PS-PAA structures was determined as 78 nm (in average). The zeta potential was determined for the PS-PAA self-assembled structures as −13 mV, indicating the expected negative charge of the structures.

The permeability data obtained from stopped-flow measurements in 0.5 M NaCl as the osmolyte lead to a fast diffusion coefficient Kᵢ of 100 s⁻¹.

### Example 2. General Purification of Aquaporin and Preparation of Aquaporin Stock Solution

Recombinant Production of Aquaporin Z

All types and variants of aquaporin water channel proteins, including aquaglyceroporins, may be used in the manufacture of membranes and compositions according to this invention, cf. methods described in WO2010/146365. Representative examples include the spinach aquaporin SoPIP2;1 protein and the bacterial aquaporin-Z from E. coli.

Functional aquaporin-Z was overproduced in E. coli strain BL21(DE3) bacterial cultures as His-tagged protein with a tobacco etch virus cleavage site. The fusion protein has 264 amino acid and a Mw of 27234 Da. Genomic DNA from E. coli DH5 was used as a source for amplifying the AqpZ gene. The AqpZ gene was amplified using gene specific primers with the addition of a tobacco etch virus cleavage site (TEV); ENLYFQSN at the N-terminus of AqpZ. The amplified AqpZ was digested with the enzyme NdeI and BamHI and then ligated to the similarly digested 6-His tagged expression pET28b vector DNA. The positive clones were verified by PCR-screening. The authenticity of the constructs was then confirmed by DNA sequencing.

The E. coli strain BL21(DE3) was used for expression of the protein. Luria Broth cultures containing 50 μg/ml kanamycin were incubated for 13-16 hours at 37 C, diluted 100-fold into fresh LB broth and propagated to a density of about 1.2-1.5 (OD at 600 nm). Expression of recombinant protein was induced by addition of 1 mM IPTG for 3 hour at 35° C. before centrifugation. Harvested cells were resuspended in ice-cold binding buffer (20 mM Tris pH 8.0, 50 mM NaCl, 2 mM β-mercaptoethanol, 10% glycerol) in the presence of 0.4 mg/ml lysozyme, 50 units Bensonase and 3% n-octyl β-D-Glucopyranoside. The sample was subjected to five times lysis cycles in a microfluidizer at 12,000 Pa. Insoluble material was pelleted by 30 minutes centrifugation at 40,000×g. The supernatant was passed through a Q-Sepharose fast flow column (Amersham Pharmacia), and the flow through was 10 collected. The flow though fraction was topped up with NaCl to 300 mM before loaded onto a pre-equilibrated Ni-NTA column. The column was washed with 100 column volumes of a wash buffer (20 mM Tris pH 8.0, 300 mM NaCl, 25 mM imidazole, 2 mM β-mercaptoethanol, 10% glycerol) to remove non-specifically bound material. Ni-NTA agarose bound material was eluted with five bed volumes of elution buffer (20 mM Tris pH 8.0, 300 mM NaCl, 300 mM imidazole, 2 mM β-mercaptoethanol, 10% 15 glycerol, containing 30 mM n-octyl β-D-Glucopyranoside). AqpZ was further purified with anion exchange chromatography; monoQ column (GE healthcare). The sample mixture was diluted and concentrated to bring the salt and imidazole concentration to approximately 10 mM with Amicon concentrator, membrane cut off 10,000 Da before loading to MonoQ column. The buffer used during anion exchange chromatography were (A) 20 mM Tris pH 8.0, 30 mM OG, 10% glycerol and (B) 20 mM 20 Tris pH 8.0, 1 M NaCl, 30 mM OG, 10% glycerol. The eluted peak fractions containing AqpZ from the ion exchange column was pooled. The purified AqpZ extract was kept frozen at −80° C.

Procedure for Purification of Aquaporin Protein

A batch of frozen extract of aquaporin protein, such as aquaporin Z, AQPZ, e.g. from an E. coli fermentation, was obtained and treated as follows for use in the experiments to produce and characterise membranes comprising protein-PAI nanostructures of the present invention.

One day before the purification experiment, the AQP extract (stored at −80° C. freezer) was thawed on ice or in a 4° C. refrigerator. Portions of the buffers and ddH2O were readied at 4° C. The AQP extract was stirred in an adequate chilled beaker on ice bath by a magnetic stick to dissolve any precipitate. 1.5 volumes of pre-chilled LDAO-free AQP binding buffer was gradually added into 1 volume of the solubilized extract (using a further 0.5 volume buffer for rinsing the extract tubes and filtration cup), mixed well and filtered through a sterile 0.45 μM vacuum filter cup. Vacuum was applied to the filter cup to avoid excess foaming and the filtrate was placed on ice to use within 2 hours.

A Histrap column was equilibrated with sterile water followed by AQP Binding buffer at RT. The flow rate was set at lml/min (for 1 mL prepacked column) or 2.5 ml/min (for 5 ml prepacked column and self-packed column). The 3 times diluted extract (on ice water bath) was loaded onto the Histrap column using AKTA program. The flow rate was set at 1 ml/min (for 1 mL prepacked column) or 2.5 ml/min (for 5 mL prepacked column and self-packed column). The loading volume was less than 30 ml/ml resin. The extract flow-through on ice-water bath was collected and stored at 4° C. for further use. The column was washed with 10 CV ice cold AQP binding buffer. The flow rate was set at 2.5 ml/min (for 5 ml prepacked column and self-packed column) or set at 1 ml/min for 1 ml prepacked column. The AQP protein was eluted with ice cold AQP elution buffer (10 column volume) at flow rate 2.5 ml/min using AKTA program. The fraction volume was set to 10 ml and collection started in 15 mL PP tubes after 0.5-1CV.

Eluted fractions were capped and stored on ice or 4° C. The AQP purity and conformation was examined by denaturing and native PAGE analysis respectively. Protein concentration was measured by Nanodrop. The extract flow-through may be processed a second and a third time as needed to produce an AQP composition of suitable quality.

When AQP quality analyses are passed, the protein concentration may be adjusted to 5 mg/ml by adding ice cold imidazole-free AQP binding buffer containing 2% LDAO. Finally the AQP was sterilized by filtration through 0.45 μM sterilized cup and stored at 4° C. in refrigerator for use within a month or else stored at −80° C. in a freezer.

### Example 3. Preparation of PS-PAA Vesicles Having AqpZ Incorporation Using LDAO as a Detergent

Materials and Methods

Polystyrene-block-poly(acrylic acid), DDMAT terminated (MW 8000 Da) (PS-PAA as in Example 1) was purchased from Sigma Aldrich and was used as received without any other purification. 10 mM phosphate saline solution (PBS) (pH 7.2, 136 mM NaCl, 2.6 mM KCl) was prepared by dissolving 8 g NaCl, 0.2 g KCl, 1.44 g Na₂HPO₄ and 0.24 g of KH₂PO₄ in 800 mL MilliQ purified H₂O, adjusting the pH to 7.2 with HCL and completing the volume to 1 L. N,N-Dimethyldodecylamine N-oxide BioXtra (Lauryldimethylamine N-oxide) (99% purity), LDAO was purchased from Sigma Aldrich). 5 mg/mLAqpZ purified stock solution in 2% LDAO, see general preparation in Example 2 above.

PS-PAA incorporating AqpZ vesicles were prepared by LDAO mediated direct dissolution method. For that 200 mg PS-PAA powder were mixed with 0.5 mL 5% LDAO stock solution and 194.9 mL PBS and 0.5 mg (0.1 mL) AqpZ purified stock solution in 2% LDAO to achieve a 1/330 AQPZ/polystyrene-block-poly(acrylic acid), DDMAT terminated molar ratio.

The PS-PAA, LDAO, AqpZ mixture was stirred overnight at 170 rotations per minute, overnight not more than 24 hours (but not less than 12 h). After stirring next day, the mixture was transferred in 100 mL glass bottle and kept at room temperature. After transfer to the storage glass bottle the size and the permeability of the PS-PAA AqpZ self-assembled structures and zeta potential were determined by dynamic light scattering using a ZetaSizer NanoZs from Malvern and stopped-flow using a Bio-Logic SFM 300.

The hydrodynamic of PS-PAA AqpZ structures was determined as 69 nm (in average). The zeta potential was determined for the PS-PAA AqpZ self-assembled structures as −14 mV, indicating the expected negative charge of the structures.

The permeability data obtained from stopped-flow measurements in 0.5 M NaCL as the osmolyte lead to a fast diffusion coefficient Kᵢ of 1000 s⁻¹.

The temperature stability of the PS-PAA AgpZ based self-assembled structures was determined by warming up 5 mL for 10 min at various temperatures ranging from 30 to 100° C. and their size and water permeability was further determined by dynamic light scattering and stopped-flow measurements. The size decrease with the temperature increase at 60° C. (reaching 39 nm), while the fast diffusion coefficient Kᵢ values do not change.

The same type of experiment was performed by using PS-PAA copolymers with Mw of from 8000 Da to 23300 Da and having hydrophilic to hydrophobic ratios from 0.4 to 3.6, and using LDAO concentrations ranging from 0.05 to 2.5% v/v.

### Example 4. Preparation of PS-PAA Vesicles Having AqpZ Incorporation Using OG as a Detergent

Materials and Methods

Polystyrene-block-poly(acrylic acid), DDMAT terminated (MW 8000 Da) (PS-PAA as in Example 1) was purchased from Sigma Aldrich and was used as received without any other purification. 10 mM phosphate saline solution (PBS) (pH 7.2, 136 mM NaCl, 2.6 mM KCl) was prepared by dissolving 8 g NaCl, 0.2 g KCl, 1.44 g Na₂HPO₄ and 0.24 g of KH₂PO₄ in 800 mL MiliQ purified H₂O, adjusting the pH to 7.2 with HCL and completing the volume to 1 L. N,N-Octyl β-D-glucopyranoside (98% purity), OG was purchased from Sigma Aldrich. 5 mg/mL AqpZ purified stock solution in 1% OG.

PS-PAA incorporating AqpZ vesicles were prepared by OG mediated direct dissolution method. For that 200 mg PS-PAA powder were mixed with 0.25 mL 10% OG stock solution and 195.15 mL PBS and 0.5 mg (0.1 mL) AqpZ purified stock solution in 1% OG to achieve a 1/330 AQPZ/polystyrene-block-poly(acrylic acid), OG terminated molar ratio.

The PS-PAA, OG, and AqpZ mixture was stirred overnight at 170 rotations per minute, overnight not more than 24 hours (but not less than 12 h). After stirring next day, the mixture was transferred in 100 mls glass bottle and kept at room temperature. After transfer to the storage glass bottle the size and the permeability of the PS-PAA AqpZ self-assembled structures and zeta potential were determined by dynamic light scattering using a ZetaSizer NanoZs from Malvern and stopped-flow using a Bio-Logic SFM 300.

The hydrodynamic diameter size of PS-PAA AqpZ vesicular structures was determined as 50 nm (in average) with peaks at 56 nm (84%) and 71 nm (16). The zeta potential was determined for the PS-PAA AqpZ self-assembled vesicular structures as −14 mV, indicating the negative charge of the structures. The permeability data obtained from stopped-flow measurements in 0.5 M NaCl as the osmolyte lead to a fast diffusion coefficient Kᵢ of 1350 s⁻¹.

### Example 5. Handmade FO Filtration Membranes Using PS-PAA 8000,/Polystyrene-Block-Poly(Acrylic Acid), DDMAT Terminated from Sigma-Aldrich

A TFC layer was formed on a PES support membrane using a manual protocol;

a) An MPD/water solution was made by dissolving 1.5 g MPD in about 55 mL of MilliQ water to get app. 2.5-3% (W/W) concentration;

b) An aqueous PS-PAA-aquaporin Z solution is mixed with the MPD solution prepared in step a): mix 6 mL PS-PAA/aqpZ solution with about 54 mL of MPD aqueous solution;

c) TMC was dissolved in Isopar to a final concentration of 0.15% W/V;

d) Cover a rectangular shaped membrane, e.g. 5.5 cm×11 cm filter membrane of 0.1 μm in pore size (MICRO PES 1FPH, manufactured by Membrana Co.) with about 20 mL/m² membrane of PS-PAA-aqpZ/MPD solution prepared in step b), and leave for 30 seconds under gentle agitation;

e) Dry the non-active side (back side) with lab drying paper (e.g. Kim-Wipe) for 5-10 seconds;

f) Put the membrane on a glass plate and dry gently with N₂ until the surface turns from shiny to dim;

g) Apply tape around the edges of the membrane (≈1 mm);

h) Put the glass plate with the taped membrane into a glass or metal container, add about 155 mL/m² membrane TMC-Isopar to one end and rock gently back and forth for 30 seconds;

i) Remove glass plate from reservoir and dry with N₂ for 10 to 15 seconds.

After removal of the tape the membrane can be transferred to MilliQ with the newly formed active side up and keep wet during handling in subsequent steps if necessary.

Five coated membranes of 5.5 cm×11 cm shapes were separately fitted into a Sterlitech CF042 FO cell and run for 200 minutes with a 5 μM calcein in DI water feed solution and a 1 M NaCl draw solution. Mean results with standard deviation are shown in Table 1 for membranes obtained by using the vesicles obtained in example 3. From the results it can be seen that the FO water flux (Jw) performance is both satisfactory and highly reproducible as shown by a low standard deviation. At the same time the reverse sodium chloride flux is low, and the ratio Js/Jw is excellent, i.e. below 0.20. The obtained calcein rejection of more than 99% is a measure characterizing a tight membrane without pin holes or other faults.

TABLE 1

| Number | | | | |
|---|---|---|---|---|
| of FO | | | | Calcein |
| membranes | Jw ± SD | Js ± SD | | rejection |
| tested | [L/m²h] | [g/m²h] | Js/Jw ± SD | % ± SD |
| 5 | 7.3 ± 0.73 | 1.37 ± 0.36 | 0.19 ± 0.04 | 99.86 ± 0.04 |

### Example 6. Pilot Machine Made FO Filtration Membranes Using PS-PAA 8000,/Polystyrene-Block-Poly(Acrylic Acid), DDMAT Terminated from Sigma-Aldrich

A TFC layer is formed on a PES support membrane using a pilot coating machine.

a) An MPD/water solution is made by dissolving MPD in MilliQ water to get a 2.5% (W/W) concentration;

b) A PS-PAA/aquaporin-Z/MPD/water solution is prepared as in steps a) and b) of Example 5;

c) TMC is dissolved in Isopar to a final concentration of 0.15% W/V;

d) A roll of filter membrane of MICRO PES 1FPH (0.1 μm in pore size;

manufactured by Membrana Co.) is installed on the unwinding unit of the machine;

e) The membrane is threaded through the coating;

f) The washing bath is filled with DI water;

g) The coating process is run (at 0.6 m/min):
membrane is unrolled from unwinder;
then soaked in MPD/water in foulard bath;
surface water is removed by air knife (0.5 bar air);
the PA-PAA/Aquaporin/MPD/water solution of step b) is applied via slot die at pump rate of 1.2 mL/min;
surface water is removed via air knife to ensure a droplet free surface before interfacial polymerization (0.75 bar);
TMC/Isopar is applied via slot die at 4.2 mL/min to start interfacial polymerization;
Isopar is dried off the surface of the membrane at ambient air;
leftover chemicals are removed in wash bath;
coated membrane is rolled up with active side pointing towards the roll;

h) The coated membrane is run through a final drying step.

Five coated membranes are cut in 5.5 cm×11 cm shapes and separately fitted into a Sterlitech CF042 FO cell and run for 200 minutes with a 5 μM calcein in DI water feed solution and a 1 M NaCl draw solution. Mean results with standard deviation of the FO water flux (Jw) performance are obtained.

### Example 7. Handmade TFC PS-PAA-AQPZ Filtration Membranes for RO Low Pressure Using PS-PAA 8000,/Polystyrene-Block-Poly(Acrylic Acid), DDMAT Terminated from Sigma-Aldrich

The membranes were made according to the steps outlined below:

a) Provide a support membrane, e.g. a PES non-woven having fingerlike structure, size 5.5 cm×11 cm (e.g. a MICRO PES 1FPH having 0.1 μm in pore size; manufactured by Membrana Co.);

b) Mix 3 wt % MPD, and 93.5 wt % DI water to obtain a solution;

c) Add 0.1 mg/mL of PS-PAA-AQPZ proteopolymersomes (self-assembled nanovesicles) prepared according to Example 3, to obtain a suspension;

d) Incubate the suspension from c) for 2 hours;

e) Prepare TMC solution from 0.09 wt % TMC, 99.01 wt % Isopar, and optionally less than about 1 wt % of an apolar solvent, such as acetone;

f) Dip coat the support membrane in the suspension d) for about 30 seconds;

g) Apply drying with air knife;

h) Add the TMC solution from e) for interfacial polymerization;

i) Follow with 2 min drying in fume hood.

Eight membranes were made and mounted in a Sterlitech CF042 RO cell, www.sterlitech.com, operated at 5 bar using 500 ppm NaCl as feed for 60 minutes. The results are indicated in table 2 below and shows that the RO water flux (Jw) performance is both satisfactory and highly reproducible, while at the same time the sodium chloride rejection is high.

| | No. of | Permeability | Rejection |
|---|---|---|---|
| | Samples | (LMH/bar) | (%) |
| PS-PAA Aqp | 8 | 9.7 ± 0.5 | 95.6 ± 0.5 |
| vesicles | | | |

### Example 8. Preparation of a Layer-by-Layer Membrane Using the PS-PAA Self-Assembled Vesicles of the Invention

LbL polyelectrolyte assembly has been employed for membrane separations, for many porous membrane substrates with different sizes and topology that can adsorb the initial polyelectrolyte layer such as poly(ether sulfone), poly(vinylamine), poly(4-methyl-1-pentene), polyamide, polyacrylonitrile (PAN), poly(vinyl pyrrolidone), anodic alumina in flat sheet, tubular or hollow fiber structures [Duong, P. H. H., Zuo, J., Chung, T-S., J. Memb. Sci. 427 (2013), 411-421].

We propose using LBL polyelectrolyte technique to prepare ultrafiltration membranes based on non-woven PES substrate and PEI/PAA polyelectrolyte layer incorporating PS-PAA AqpZ nanostructures. In order to prepare the membranes, the following steps will be employed.

Step 1. Select and prepare the negatively charged PES on the non-woven support;

Step 2. Adsorb PEI on the negatively charged surface of the substrate due to the electrostatic attraction; by just immersion in PEI solution;

Step 3. Wash the substrate surface with de-ionized water in order to remove excess PEI molecules which are not strongly adsorbed on the surface;

Step 4. Immerse the PES covered with PEI into PS-PAA Aqpz solution, where the negative charges will be adsorbed onto the surface;

Step 5. Wash the substrate surface with de-ionized water in order to remove excess PS-PAA AqpZ structures which are not strongly adsorbed on the surface;

Step 6. Immerse the PES covered with negative charges from PS-PAA Aqpz solution into PEI solution;

Step 7. Wash PES surface covered with PEI and PAA AgpZ structures with de-ionized water in order to remove excess PEI molecules;

Step 8. Adsorb PS-PAA on the positively charged surface by direct immersion in 2 mg/mL PS-PAA 8000 Da solution;

Step 9. Wash PES surface covered with PS-PAA and PEI structures with de-ionized water in order to remove excess PS-PAA molecules;

Step 6. Repeat steps 6-9 until reaching the targeted number of multilayers−2;

Step 8. Wash with deionized water

In case other pairs of electrolytes are preferred similar procedure will be used in order to prepare the membranes. PS-PAA AqpZ based nanostructures will be used to replace the polyanion used to assembly the electrolyte multilayers.

### Example 9: Preparation of a Layer-by-Layer (LBL) Membrane Incorporating Aquaporin Vesicles

Materials:

PAH—Polyallylamine 40 wt % in water; Mw=150,000 g/mol; Manufactured by Nittobo; grade: PAA-HCL-10L.

PSS—Poly(sodium 4-styrenesulfonate) solution 30 wt % in water; Mw=200,000 g/mol; Manufactured by Sigma-Aldrich.

NaCl—Sodium chloride; Manufactured by Akzo Nobel.

Fibers—Ultrafiltration membranes made by TWENTE University from sulfonated polyethersulfone with poly(diallyldimethylammonium chloride). Inner diameter is 0.68 mm and the outer diameter is 0.88 mm. The fiber has a standard permeability of around 200 Lmhb (L*m⁻²*h⁻¹*bar⁻¹).

Preparation of LBL

The polyelectrolyte multilayer (PEM) was prepared by dipping the fibers in a 0.5 M of NaCl and 0.1 g/l of polyelectrolyte solution. The polyelectrolytes were PAH (polyallylamine) and PSS (polystyrene sulfonate) and all solutions were made with deionized water. The fibers were first put into the PSS solution for 15 minutes, then were rinsed in three separate cylinders for 5 minutes each. Subsequently, the fibers were put into the PAH solution also for 15 minutes. This was repeated until a 7 bilayer system ([PSS/PAH]₇) was made.

Since the vesicles have a negative charge, they should be attach onto the positively charged surface. A module was made from the membrane where one side was closed off like a dead-end filtration. The module was constructed from a PE tube with a hole in the bottom. The PS-PAA Aqpz vesicles solution prepared in example 4 were put into a syringe and then connected to the membrane module. The vesicle solution was subsequently allowed to flow through the inside of the membrane until all the air is out. Then one side is closed off like a dead end filtration and the PS-PAA solution is pushed through, from the inside to the outside, until the membrane starts dripping.

After this, the membrane is dried for at least 4 hours in 15/85 wt % glycerol/water and then dried overnight before any further measurements were done.

For this specific case a single salt concentration for building the PEM was used. This can, however, be varied from 5 to 1000 mM (0.005 to 1.0 M) of NaCl.

| Number of RO | Jw ± SD | Rejection % |
|---|---|---|
| membranes tested | [L/m²h/bar] | [NaCl] ± SD |
| 4 | 6.46 ± 0.3 | 44.1 ± 4 |

Similar results for the rejection of salt were described by Zhang T et al 2013.

### Example 10. Characterization of the PS-PAA Vesicles of the Invention Using Laser Scanning Microscopy and Scanning Electron Microscopy

The morphology as well the size of the formed PS-PAA AqpZ and PS-PAA vesicles will characterized by transmission electron microscopy on a Tecnai T20 G2 electron microscope which was operated at 100 kV. Vesicles dispersions will be deposited on a carbon-coated copper grid and negatively stained with 2% uranyl acetate solution.

Scanning electron microscopy of the cross section of prepared TFC and LBL membranes will be performed on a FEI Inspect S microscope.

### Example 11. Characterization of Various PS-PAA-AqpZ Handmade FO Membranes Using 5 μM Calcein as Feed and 1 M NaCl Standard Solutions as Draw in a Standard Test Setting Using the Sterlitech CF042 Flow Chamber

All Membranes were Prepared Using the Protocol of Example 6 Above.

Equipment:
Flexible silicone tubing (Tygon L/S25—di=4.8 mm)
Conductivity meter (Thermo Scientific Orion 3 star+data logging software (StarPlus Navigator, LabSpeed Navigator)
Conductivity probe (Thermo Scientific 013016MD cell constant 0.1/cm working range 0.1-300 μS)
Pumps (Longer BT100-1L with 3 roller pumps head YZ1515x)
Magnetic stirrers (Assistent Magnetmix 2070)
Kern Scale 572+software Balance connection 4
CF042 FO-cell
1 CF042 sized membrane prepared as described above
2 bottles (feed/draw reservoir, plastic or glass) Draw: 2 L and feed 1 L volume
Invitrogen Qubit Flourometer Q 32857 Gonotec Osmomat 030 Cryoscopic Osmometer
Lab boy or similar to raise draw reservoir.

Summary of Standard FO Test Setup:
membrane orientation: AS-FS
run-time: >215 min/analysis time: 200 min (15 min run-in time not included in recording)
flow speed on pump: 50 mL/min
Draw: 1M NaCl
Feed: 5 μM calcein in DI water
Same height of feed and draw top surface at start

Preparation of the FO Station:

1. Fill the draw reservoir with 1 L of a 1M NaCl solution and note down the weight on the report sheet.

2. Fill the feed reservoir with 1 L of a 5 μM calcein solution and note down the weight on the report sheet.

3. Ensure that the height of the water level in draw and feed are on the same level (use a lab boy or similar to raise the magnetic stirrer)

4. Fill the entire system (feed and draw) via the pump (high speed)

5. Set the pump speed to 50.03 mL/min (tube inner diameter 4.8 mm)

Results are given in Tables 2 to 5 below where desirable Jw/Js ratios ranging from the very low 0.11 and up to 0.37 are obtained in all experimental runs. In addition, very high calcein rejections of more than 99.7% were found in all runs proving the faultless nature of the tfc layer.

TABLE 2
200 min run time

| PS-PAA | | | | |
|---|---|---|---|---|
| 8000* | Jw | Js | | Calcein |
| 2-0.1-5** | [L/m²h] | [g/m²h] | Jw/Js | rej. Rca |
| | 7.91 | 1.63 | 0.21 | 99.88 |
| | 7.28 | 1.75 | 0.24 | 99.78 |
| | 6.79 | 1.42 | 0.21 | 99.77 |
| | 5.06 | 0.60 | 0.12 | 99.96 |
| | 6.17 | 1.24 | 0.20 | 99.82 |
| | 5.89 | 0.66 | 0.11 | 99.84 |

*Purchased from Sigma-Aldrich, cf. Ex. 3
**2 mG/mL PS-PAA:0.1 mG/mL LDAO:5 mg/L AqpZ

TABLE 3
900 min run time

| PS-PAA | | | | |
|---|---|---|---|---|
| 8000* | Jw | Js | | Calcein |
| 2-0.1-5** | [L/m²h] | [g/m²h] | Jw/Js | rej. Rca |
| | 7.21 | 1.3 | 0.18 | 99.87 |
| | 6.73 | 2.46 | 0.37 | 99.75 |
| | 6.16 | 1.36 | 0.22 | 99.71 |

*Purchased from Sigma-Aldrich, cf. Example 3
**2 mG/mL PS-PAA:0.1 mG/mL LDAO:5 mg/L AqpZ

TABLE 4
200 min run time

| PS-PAA | | | | |
|---|---|---|---|---|
| 23300* | Jw | Js | | Calcein |
| 2-0.2-5** | [L/m²h] | [g/m²h] | Jw/Js | rej. Rca |
| | 7.43 | 2.11 | 0.28 | 99.81 |
| | 7.33 | 1.87 | 0.26 | 99.76 |
| | 7.58 | 1.43 | 0.19 | 99.83 |
| | 7.71 | 1.65 | 0.21 | 99.95 |
| | 7.43 | 2.11 | 0.28 | 99.81 |

*Purchased from Sigma-Aldrich, cf. Example 3
**2 mG/mL PS-PAA:0.2 mG/mL LDAO:5 mg/L AqpZ

TABLE 5
200 min run time

| PS-PAA | | | | |
|---|---|---|---|---|
| 13000* | Jw | Js | | Calcein |
| 2-0.25-5** | [L/m²h] | [g/m²h] | Jw/Js | rej. Rca |
| | 8.89 | 1.9 | 0.21 | 99.72 |
| | 8.73 | 1.32 | 0.15 | 99.78 |
| | 6.25 | 0.99 | 0.16 | 99.77 |
| | 6.95 | 1.18 | 0.17 | 99.89 |
| | 6.84 | 1.35 | 0.20 | 99.87 |

*Purchased from Sigma-Aldrich, cf. Example 3
**2 mG/mL PS-PAA:0.25 mG/mL LDAO:5 mg/L AqpZ

### REFERENCES

The following references are all incorporated by reference in their entirety.
Zhang Y, Xiao X, Zhou J-J, Wang L, Li Z, Li L, Shi L, Chan C. Re-assembly behaviors of polystyrene-b-poly(acrylic acid) micelles, Polymer, 2009, 50, 6166-6171
Choucair A, Lavigueur C, Eisenberg A. Polystyrene-b-poly(acrylic acid) Vesicle Size Control Using Solution Properties and Hydrophilic Block Length, Langmuir 2004, 20, 3894-3900.
Spulber M, Najer A, Winkelbach K, Glaied O, Waser M, Pieles U, Meier W, Bruns N, Photoreaction of a Hydroxyalkyphenone with the Membrane of Polymersomes: A Versatile Method To Generate Semipermeable Nanoreactors, J. Am. Chem. Soc., 2013, 135 (24), 9204-9212.
Lomora M, Garni M, Itel F, Tanner P, Spulber M, Palivan C G Polymersomes with engineered ion selective permeability as stimuli-responsive nanocompartments with preserved architecture. Biomaterials, 2015, 53, 406-414.
Linqi S, Wangqing Z, Fenfang Y, Yingli A, Huan W, Lichao G, Binglin H. Formation of flower-like aggregates from assembly of single polystyrene-b-poly(acrylic acid) micelles, New J. Chem., 2004, 28, 1032-1048.
Lichao G, Linqi S, Wangqing Z, Yingli A, Xiaowei J. Expulsion of Unimers from Polystyrene-block-poly(acrylic acid) Micelles, Macromol. Chem. Phys., 2006, 207, 521-527.
Vyhnalkova R, Eisenberg A, van de Ven T G M, Loading and Release Mechanisms of a Biocide in Polystyrene-Block-Poly(acrylic acid) Block Copolymer Micelles, J. Phys. Chem. B, 2008, 112, 8477-8485.
Guennouni Z, Cousin F, Fauré M C, Perrin P, Limagne D, Konovalov O, Goldmann M, Self-Organization of Polystyrene [symbol] b [symbol] polyacrylic Acid (PS [symbol] b [symbol] PAA) Monolayer at the Air/Water Interface: A Process Driven by the Release of the Solvent Spreading, Langmuir, 2016, 32, 1971-1980.
Wang X, Ma X, Zang D, Aggregation behavior of polystyrene-b-poly(acrylic acid) at the air-water interface, Soft Matter, 2013, 9, 443-453.
Zhang T et al 2013, LBL Surface modification of a nanofiltration membrane for removing the salts of glutathione solutions, Ind. Eng. Chem. Res. 2013, 52, 6517-6523.

1. A vesicle comprising polystyrene-polyacrylic acid (PS-PAA) block copolymer and an amphiphilic functional molecule.

2. The vesicle according to claim 1, wherein said block copolymer has a molecular weight of from about 7500 Da to about 25000 Da

3. The vesicle according to claim 1 or 2, wherein said PS-PAA block copolymer is selected from block copolymers having the molecular weights 8000 Da, 13000 Da and 23300 Da.

4. The vesicle according to any of the claims claim 1 or 2, wherein the PS-PAA block copolymer has a hydrophilic to hydrophobic ratio in the range of from about 0.4 to about 3.6.

5. The vesicle according to any one of claims 1 to 4, wherein the PS-PAA block copolymer has an end functionalization.

6. The vesicle according to claim 5, wherein the end functionalization is selected from an azide group, a carboxyl group, or a DDMAT group exhibiting a thiol moiety.

7. The vesicle according to any of the claims 1 to 6, which has a hydrodynamic diameter of from about 50 nm to about 300 nm at room temperature.

8. The vesicle according to any of the claims 1 to 7, which is present in the form of an emulsion or a mixture composition prepared by direct dissolution in an aqueous medium in the presence of a detergent.

9. The vesicles according to an of the claims 1 to 8, wherein the detergent is selected among lauryldimethylamine-N-Oxide (LDAO) and octyl glucoside (OG).

10. The vesicles according to claim 8 or 9, wherein the detergent is used in a concentration in the range of 0.05 to 2.5% v/v.

11. The vesicle according to any one of claims 1 to 10, wherein the molar ratio of copolymer:detergent:AqpZ is in the range of from about 1:0.017:0.0008 to 1:0.19:0.0047.

12. The vesicle according to any one of the claims 1 to 11, wherein the amphiphilic functional molecule is selected from the group of amphiphilic peptides and transmembrane proteins.

13. The vesicle according to claim 12, wherein said transmembrane protein is an aquaporin water channel.

14. The vesicle according to claim 13, wherein said aquaporin water channel is selected from aquaporin Z, aquaporin-1, aquaporin-2 or SoPIP2;1.

15. The vesicle according to any of the claims 1 to 14, which is stable in admixture with a 3% aqueous m-phenylene-diamine (MPD) solution for at least about 12 h.

16. The vesicle according to any one of the claims 1 to 15, wherein the emulsion or mixture composition substantially does not include organic solvents, such as dioxane or dimethylformamide.

17. A selectively permeable membrane comprising a support layer and a selective layer, wherein the membrane comprises vesicles according to any one of claims 1 to 16 incorporated in the selective layer.

18. The selectively permeable membrane according to claim 17, wherein the selective layer is a thin-film composite (TFC) layer.

19. The selectively permeable membrane according to claim 17, wherein the selective layer has a layer-by-layer (LBL) structure.

20. The membrane according to claim 18 or claim 19, wherein the vesicles are fully negatively charged at pH>5 offering an increased incorporated vesicle packing density in the selective layer.

21. The membrane according to any one of claims 17 to 20 in the form of a flat sheet membrane, a hollow fiber membrane or a tubular membrane.

22. A method of preparing PS-PAA block copolymer vesicles having incorporated an amphiphilic functional molecule, comprising the steps of providing an aqueous composition comprising PS-PAA block copolymer vesicles and incorporating the amphiphilic functional molecule in the presence of a detergent.

23. The method according to claim 22, wherein the incorporation of the amphiphilic functional molecule in the polystyrene-polyacrylic acid (PS-PAA) block copolymer vesicle is effected by direct dissolution in an aqueous medium in the presence of a detergent.

24. The method according to claim 22 or 23, wherein the composition substantially does not include organic solvents, such as dioxane or dimethylformamide.

25. The method according to any one of the claims 22 to 24, wherein said amphiphilic functional molecule is a peptide or protein, such as a transmembrane protein, such as an aquaporin water channel.

26. Use of the membrane according to any one of claims 17 to 20 in a low pressure reverse osmosis (LPRO) process.

27. The use according to claim 26 wherein said process is a water purification process.

28. A low pressure reverse osmosis apparatus for water purification comprising the selectively permeable membrane according to any one of claims 17 to 20.

29. The apparatus according to claim 28 which is a household water purifier operating at a pressure below about 5 bar.

30. A brackish water reverse osmosis (BWRO) apparatus comprising the selectively permeable membrane according to any one of claims 17 to 20.
